(19) United States
(12) Patent Application Publication
(10) Pub. No.: US 2023/0371477 A1
(43) Pub. Date: Nov. 23, 2023

(54) BEEKEEPING HIVE AND METHOD OF BEEKEEPING

(71) Applicant: Gate Hive Ltd., Carlisle (CA)

(72) Inventor: Grant Richard Jobb, Carlisle (CA)

(21) Appl. No.: 18/030,064

(22) PCT Filed: Oct. 1, 2021
(86) PCT No.: PCT/CA2021/051372

§ 371 Date: Apr. 3, 2023

Related U.S. Application Data
(60) Provisional application No. 63/086,808, filed on Oct. 2, 2020.
(60) Provisional application No. 63/161,039, filed on Mar. 15, 2021.

(51) Int. Cl. A01K 47/06

(52) U.S. Cl. CPC A01K 47/06

(57) ABSTRACT

A beekeeping hive base having a container with a bottom and a continuous wall extending upwardly from the bottom about a perimeter thereof. Two spaced apart openings extend through the walls. Each of the two openings is positioned so as to allow with corresponding openings of two adjacent hive bases. A respective gate assembly is mounted to a sidewall for selectively closing and opening each of the openings A beekeeping method is provided using beekeeping hives having such a hive base.

### FIELD OF THE INVENTION

This invention relates to beekeeping. More particularly, the invention provides a novel beekeeping hive arrangement which facilitates a novel beekeeping method.

### BACKGROUND OF THE INVENTION

There are a number of beekeeping hive designs including the Langstroth, Warre and Top Bar hives.

Unlike the Langstroth and Warre designs, the Top Bar hive is a non-stacked arrangement. The present invention relates to beehive designs where the hives can be placed horizontally adjacent one another rather than vertically stacked.

To remove honey from conventional hives, the beekeeper will typically use smoke to subdue the bees to enable removal of honeycombs. Even so, the removal of the combs of honey typically results in some swarming of bees and the beekeeper would wear a beekeeping suit to avoid being stung.

It is an object of the present invention to provide apparatus and method whereby bees can be separated from honey without the use of smoke or disturbance as in conventional methods.

### SUMMARY OF THE INVENTION

The present invention utilizes a beekeeping hive having two or more passages through the sides thereof. Depending on the juxtaposition of the hives, the passages may be primarily inlet passages or outlet passages.

The bee hives are placed side by side with adjacent passages registering.

The first hive would typically house the queen bee and would generally be used for rearing new bees.

The second and third hives are utilized by the hive to make beeswax comb and to fill the comb with honey. As the comb and honey are formed, the second box will eventually fill up as bees prepare the comb to be filled in the third hive.

The passages through the walls of the hive are provided with a gate which may be moved between an open and a closed configuration.

To access honey in the second hive, the gates are closed, the second hive is removed and the first and third hives are placed adjacent one another. The gates between the first and third hives are opened so that bees can resume their hive work.

The second hive has been removed and sealed to prevent bees in the workspace. The second hive may be placed adjacent the third hive (now in the position formerly occupied by the second hive) and the bee escape may be placed between the second hive and the third hive with the gates open to enable the bees to escape from the second hive into the third hive. Once the bees have escaped, the gates are closed and honey may be harvested from the second hive which should be substantially devoid of bees.

A beekeeping hive base is provided which comprises a container having a bottom and a continuous wall extending upwardly from the bottom about a perimeter of the bottom. Two spaced apart openings extend through the wall, each of the two openings is positioned so as to allow it to register with a corresponding opening of an adjacent hive base.

A respective gate is mounted to the base for selectively closing and opening each of the openings.

The beekeeping hive base may be box-shaped with a rectangular bottom.

The openings may extend through opposite sides of the continuous wall.

The gate may comprise a respective generally U-shaped frame extending about each opening and defining a channel extending into an inner face of the U-shaped frame. A plate may be slidably received in the channel in the frame to act as the gate.

In an alternative embodiment, the gates may cover top and bottom faces of the hives and the hives may be stacked vertically.

The beekeeping hive base may be the base of a Top Bar hive, Langstroth hive or similar.

### DESCRIPTION OF THE DRAWINGS

These and other features of the present disclosure will become more apparent from the following description in which reference is made to the appended drawings wherein:

FIG. 1 is a perspective view of a beekeeping hive base according to the present invention;

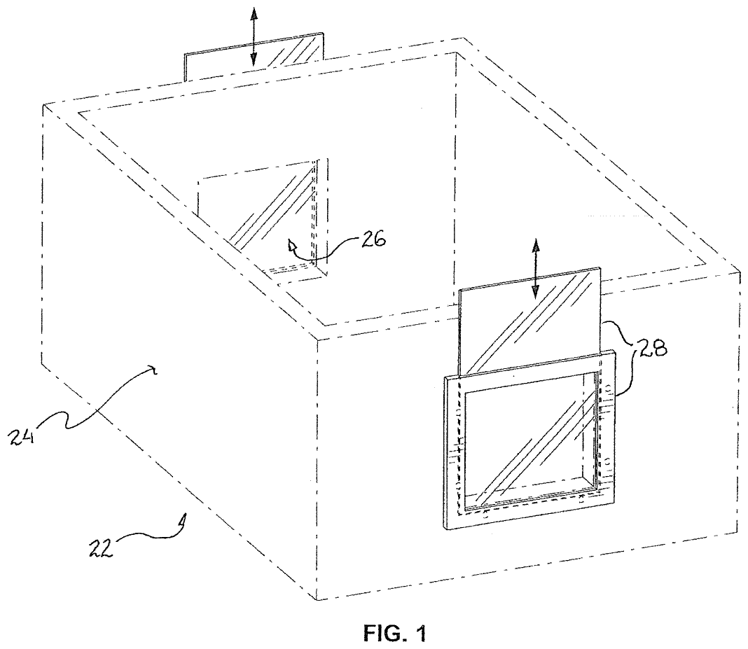

FIG. 2 is a perspective view from the front of a gate portion of the beekeeping hive base;

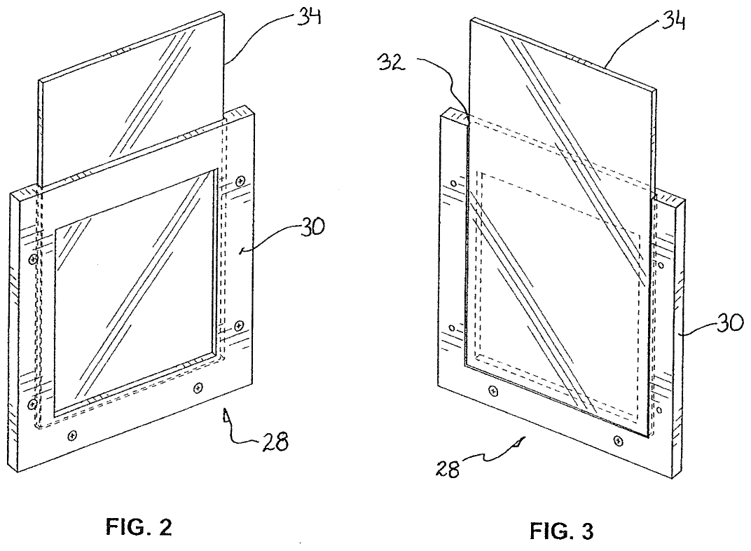

FIG. 3 is a rear perspective view of the gate;

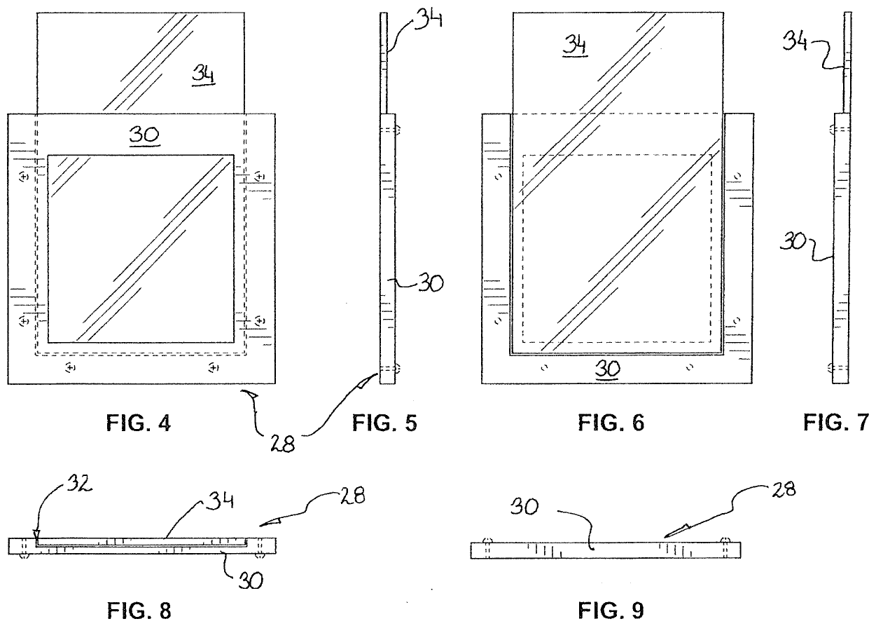

FIG. 4 is a front elevation of the gate;

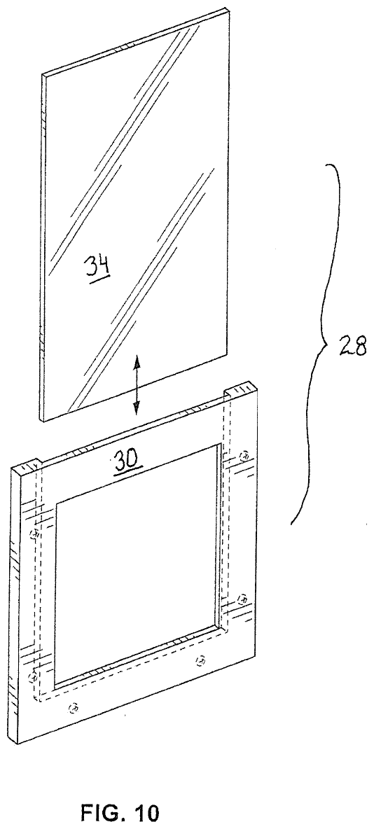

FIG. 5 is a right side elevation of the gate;

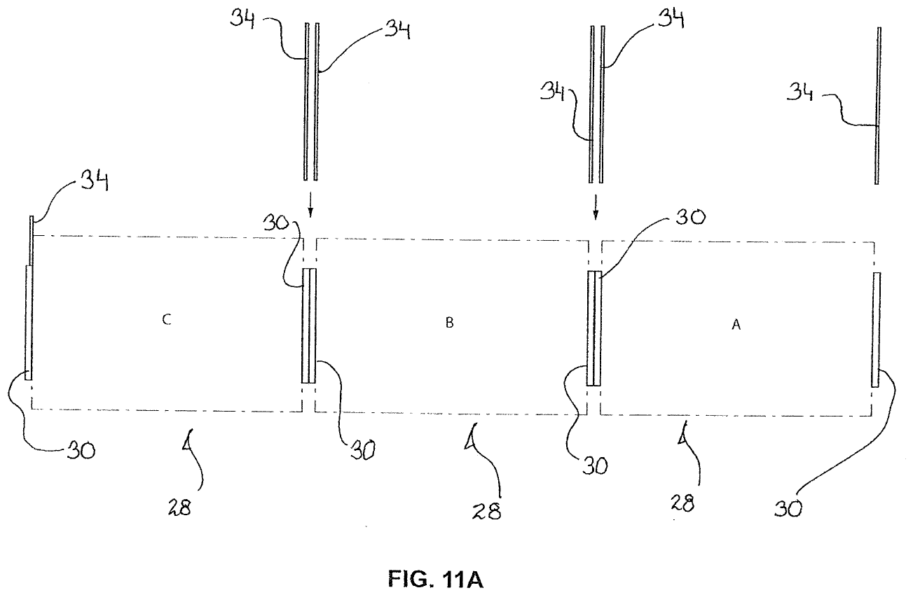

FIG. 6 is rear elevation of the gate;

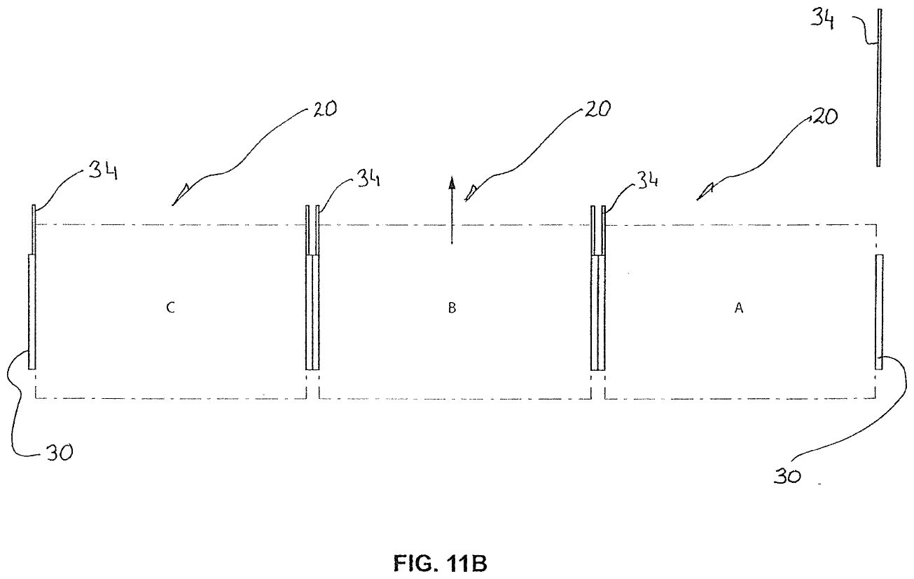

FIG. 7 is a left side elevation of the gate;

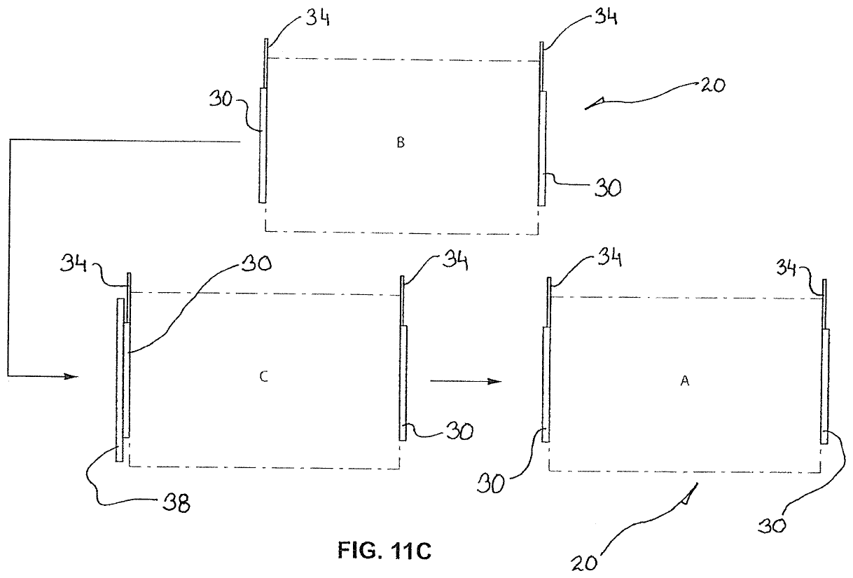

FIG. 8 is a top plan view of the gate;

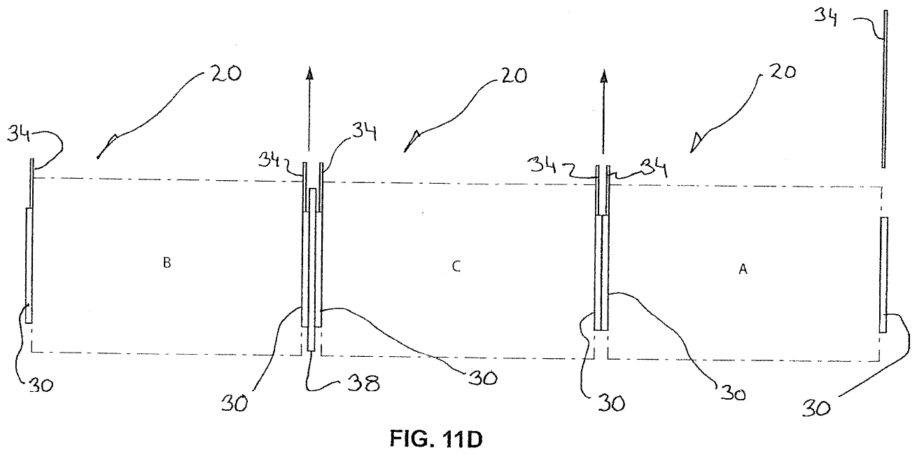

FIG. 9 is a bottom plan view of the gate;

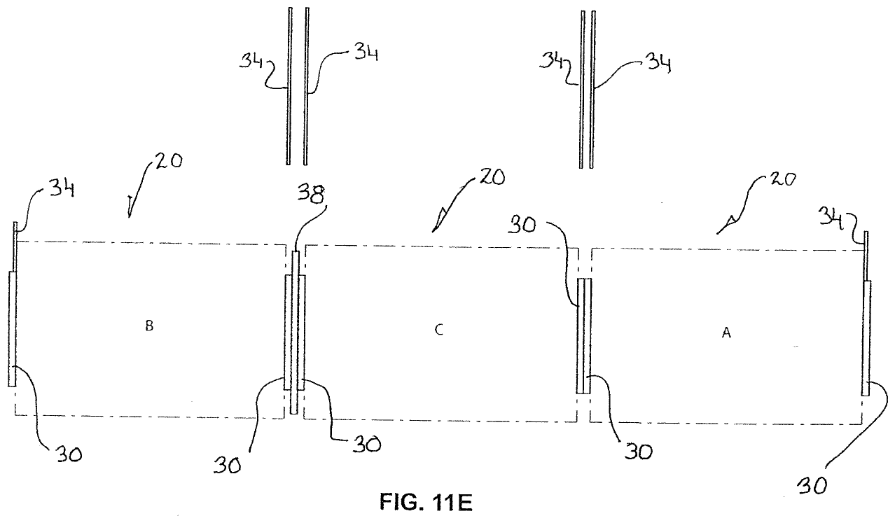

FIG. 10 is an exploded perspective view of the gate; and

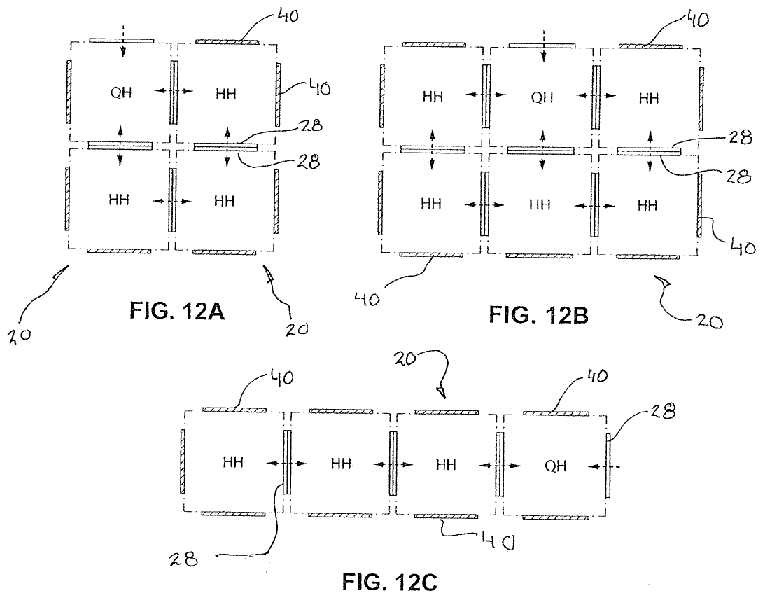

FIGS. 11A through 11E illustrate steps in a beekeeping method using three beekeeping hives having beekeeping hive bases according to FIGS. 1 through 10.

FIGS. 12A through 12C illustrate hive arrangements with more than three hives.

FIG. 13 is a perspective view showing an alternative embodiment of a beekeeping hive enclosure according to the present invention in an open configuration;

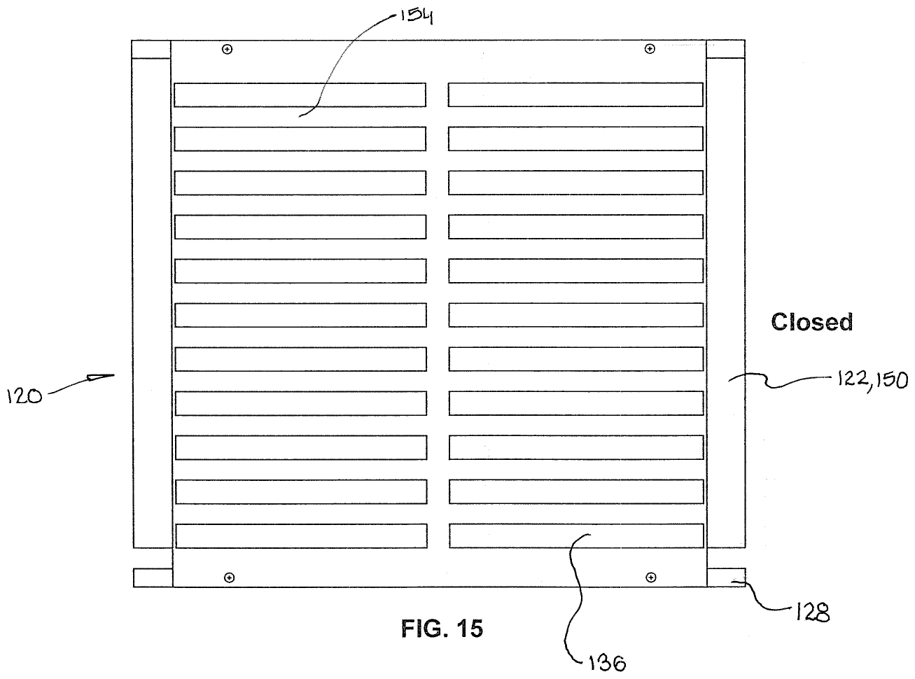

FIG. 14 is a perspective view corresponding to FIG. 13 but showing a closed configuration;

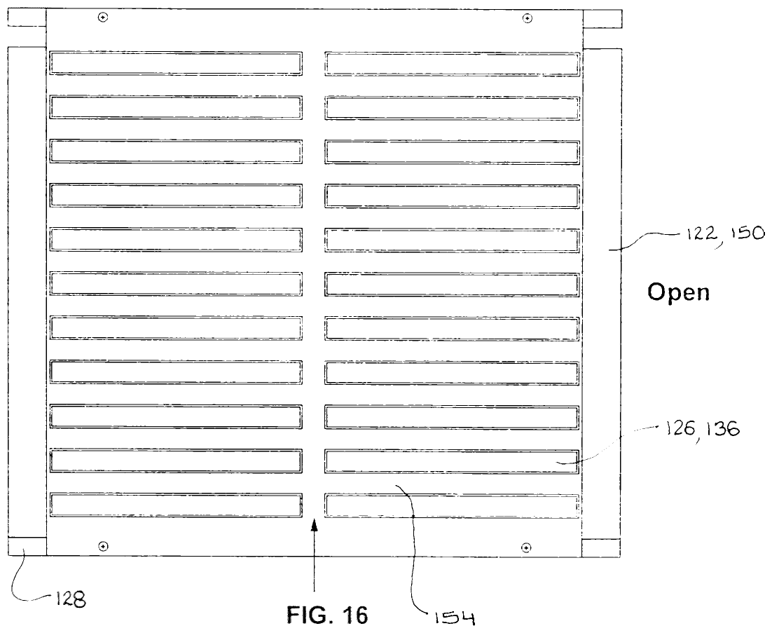

FIG. 15 is a plan view showing a gate in a closed configuration;

FIG. 16 is a plan view showing the gate in a closed configuration;

FIG. 17 is an elevation showing the beekeeping hive with gates in the open configuration;

FIG. 18 is an elevation showing the beekeeping hive in the closed configuration;

FIGS. 19 through 22 illustrate steps in a beekeeping method using beekeeping hives according to FIGS. 13 to 18; and,

FIG. 23 is a perspective view of a prior art bee excluder.

### DETAILED DESCRIPTION OF THE INVENTION

A beekeeping hive base is generally indicated by reference 20 in the drawings. The base 20 comprises a container having a bottom 22 and a continuous wall 24 extending upwardly from the bottom 22 about a perimeter of the bottom. Two spaced apart openings 26 extend through the wall 24 to enable ingress and egress of bees into and out of the container.

The base is illustrated as having an open top, and in use bars would be placed across the top from which bees may start building comb hanging vertically or Langstroth frames may be used.

The openings 26 are positioned so as to allow registering with corresponding openings 26 of two adjacent hive bases 20. Generally, this would be accomplished, as illustrated, by having the openings 26 through opposite sides of the wall 24. This enables the hives to be placed in a row. It would also be possible to have the openings 26 in other positions, such as perpendicular to each other as long as bees can enter a first of the hives pass through the first of the hives into a second of the hives and pass from the second of the hives into a third of the hives or more.

Gate assemblies 28 cover the openings 26. The gate assemblies 28 are movable between an open and a closed configuration in which they respectively open and close in the openings 26.

The gate assembly may comprise a respective frame 30 extending about each of the openings and defining a channel 32 for receiving a movable plate 34 adjacent the openings 26 and defining a channel for slidably receiving a movable plate 34 adjacent the opening. The frame 30 has a passage 36 therethrough which registers with the opening 26 to permit ingress and egress of bees through the opening 26 when the gate assembly 28 is in an open configuration.

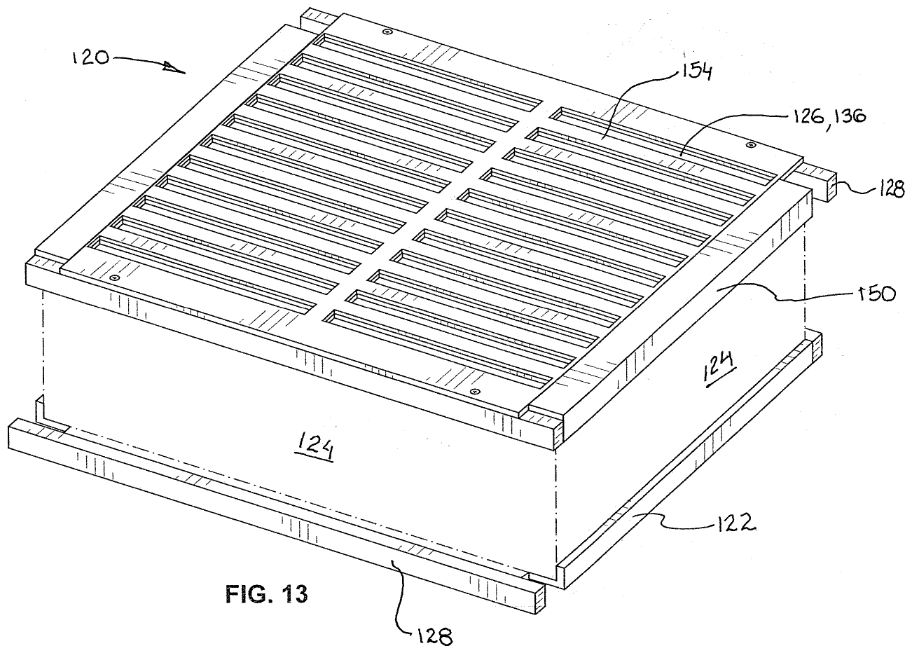

The beekeeping method is illustrated in FIGS. 11A through 11E.

FIG. 11A shows three beekeeping hives C, B and A arranged from left to right in that sequence. The right hand of the frame 30 of the C hive is in face-to-face juxtaposition with the left hand frame 30 of the B hive with their openings registering so as to permit passage of bees from the C hive into the B hive. Similarly, the right hand frame of the B hive and the left hand frame of the A hive are in face-to-face juxtaposition with their openings registering so as to permit passage of bees between the B hive and the A hive.

Prior to the sequence illustrated in FIG. 11A, the gate 34 on the right side of the A hive would have been open to permit ingress of bees into the A hive. The A hive would typically house the queen bee and is generally used for rearing new bees. A queen excluder (not shown) would be utilized to prevent migration of the queen bee to the B and A hives.

The bees would use the B hive and C hive to make beeswax comb and to fill the comb with honey. Once the comb and honey are formed in the B hive, it will eventually fill up as bees prepare comb to be built in the C hive.

Once the B hive is filled, plates 34 would be inserted into the frames between the C, B and A hives. The plate 34 on the right hand side of the A hive would remain in its open configuration.

FIG. 11A shows the plates 34 being inserted. FIG. 11B illustrates the hive arrangement once all of the plates 34 have been used to close the gates 28. Once the gates are closed between each hive, the B hive is removed from between the C and A hives. As illustrated in FIG. 11C, the B hive is removed from between the C hive and the A hive. The C hive is moved into the position previously occupied by the B hive. The B hive is in turn moved into the position formerly occupied by the C hive.

A bee escape 38 is placed between adjacent gates of the B hive and C hive as shown in FIG. 11D. A bee escape is a device used by beekeepers which acts a unidirectional passageway between two openings. The bee escape 38 would therefore be positioned to cause the bees to migrate from the B hive into the C hive.

As shown in FIG. 11D, the plates between the B, C and A hives in the process of being opened. FIG. 11E shows the gates in the open configuration. The bees in the B hive would pass through the bee escape 38 into the C hive until the B hive is substantially devoid of bees. At this stage, the gates between the B hive and the C hive would be closed enabling access to the B hive for the removal of comb and honey without bees swarming in the B hive, potentially stinging the beekeeper.

In order to practice the method of the present invention, the minimum requirement is three hive bases 20, each having at least two openings 26 therethrough. It will be appreciated by those skilled in the art that the method may be practiced using more than three hives and that the hives do not necessarily have to be arranged in a line.

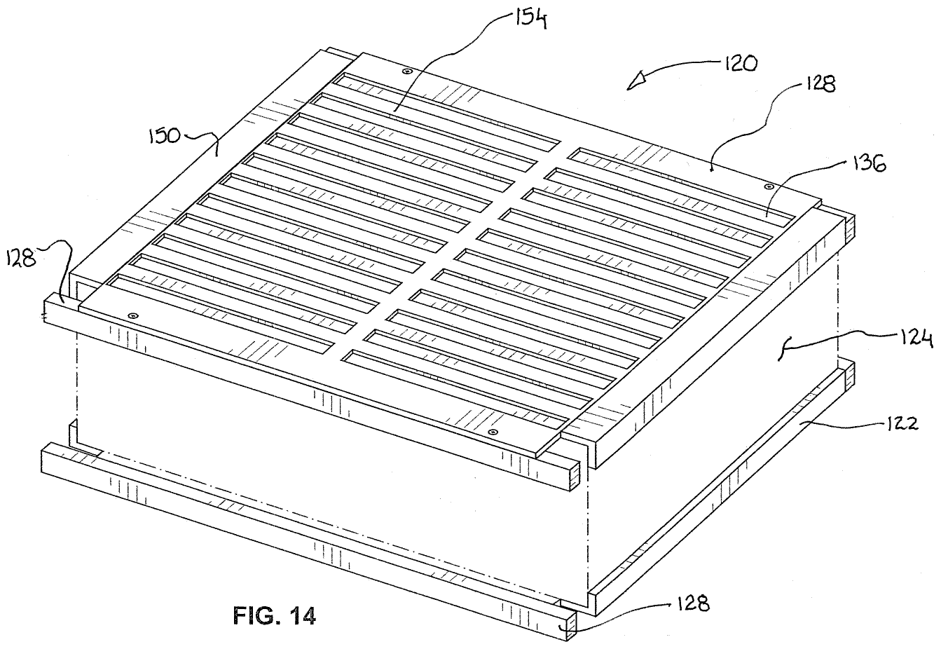

FIGS. 12A through 12C illustrate different hive arrangements with more than three hives. FIG. 12A shows an arrangement with one queen hive QH and three honey hives HH set out in a square. FIG. 12B illustrates one queen hive QH and five honey hives HH arranged in a rectangle. FIG. 12C illustrates one queen hive QH and three honey hives HH arranged in a line. Accordingly, the arrangement of hives is somewhat modular and the number of hives and the layout of the hives may be varied without departing from the scope of the present invention.

As shown in FIGS. 12A-12C, the hives HH and HQ may be provided with four openings, one on each of four sides. Although all of the openings may have gates 28 only two require gates at any given time. The other two openings may be provided with covers 40, which may be a rectangular plate.

In use, some of the gates 28 would be opened to have the queen hive QH in communication with a honey hive HH, which in turn would communicate with another honey hive HH in the same sequence as described above with respect to FIGS. 11A-11E.

A universal four gate hive allows interchangeable position and orientation. In the FIG. 12B arrangement, no hive needs to be removed from its initial position when the beekeeper wants to access the hive. The chosen gates 28 are closed and then the associated honey hive HH is moved away from the queen hive QH enough to allow the bee escape to be inserted. The gates 28 accessing the bee escape are opened (leading back to the queen box). The remaining gates 28 are left closed. Within twenty four hours, the bees should be gone from the isolated honey hive HH.

An alternative embodiment beekeeping hive is generally indicated by reference 120 in the drawings. The hive 120 comprises a base 122 and a continuous wall 124 extending upwardly from the base 122 about a perimeter of the base. Apertures 126 extend through the base 22 to enable ingress and egress of bees into and out of the hive 120.

The hive 120 is illustrated as having a removable lid 150, beneath which, in use, bars would be placed across a top of the hive 120 from which bees may start building comb hanging vertically. Alternatively, Langstroth frames may be used. The lid 150 also has apertures 126 extending therethrough.

The apertures 126 are positioned so as to allow registering of lid apertures 126 with corresponding base apertures 126, apertures of two vertically adjacent hives 120.

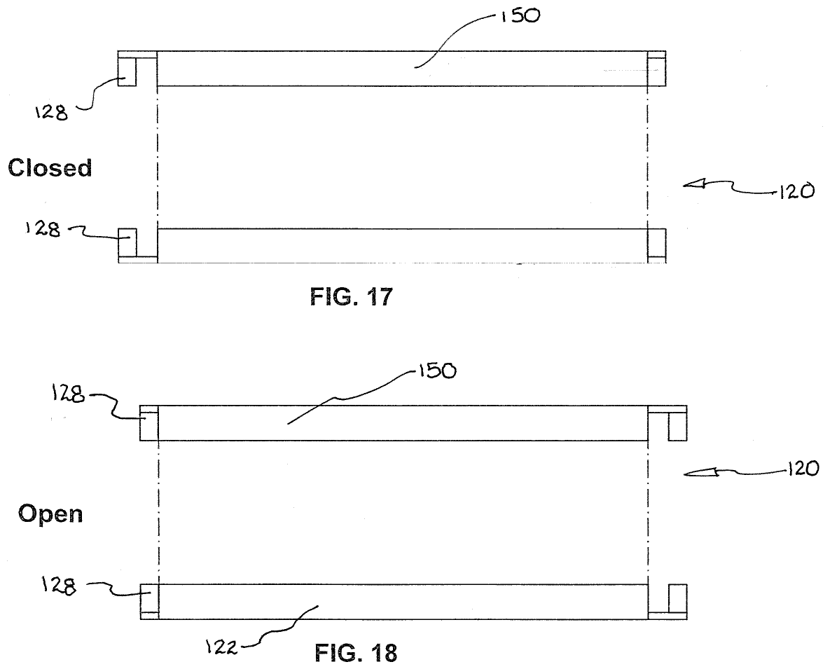

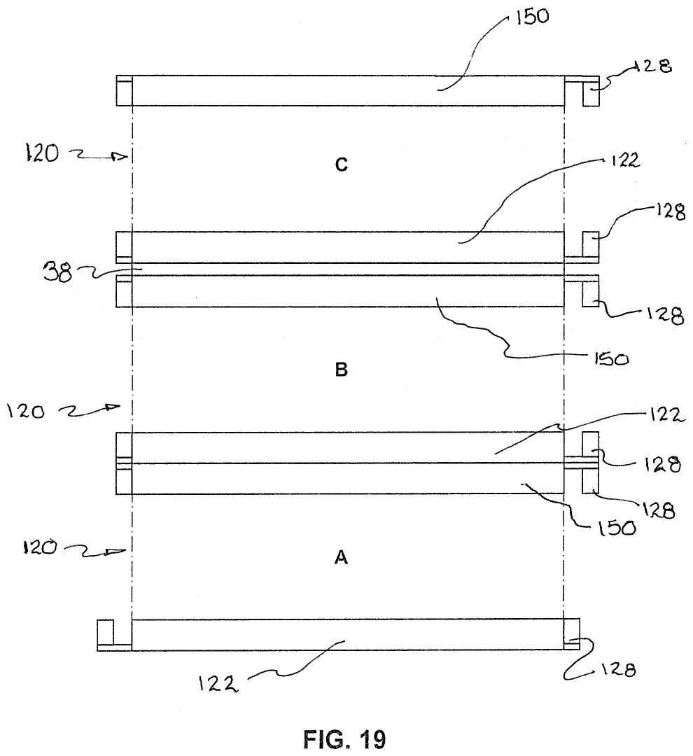

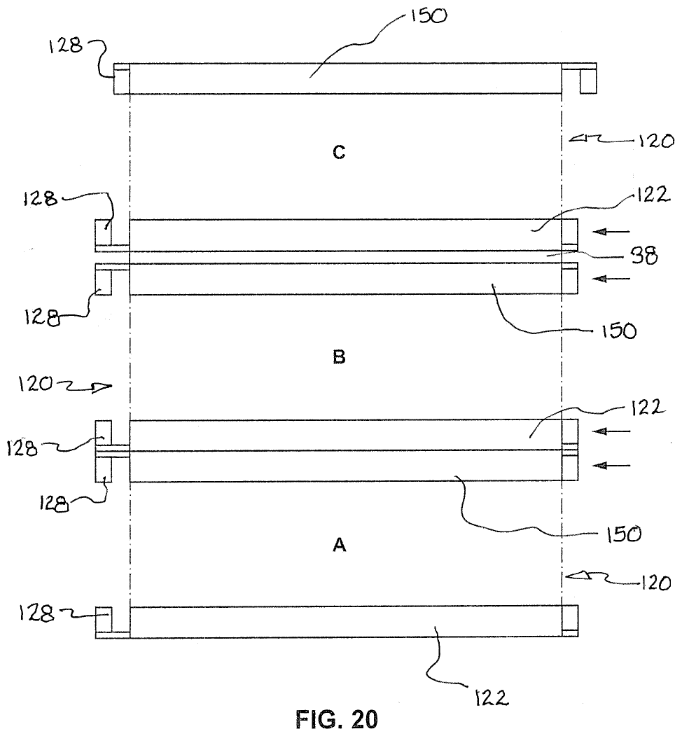

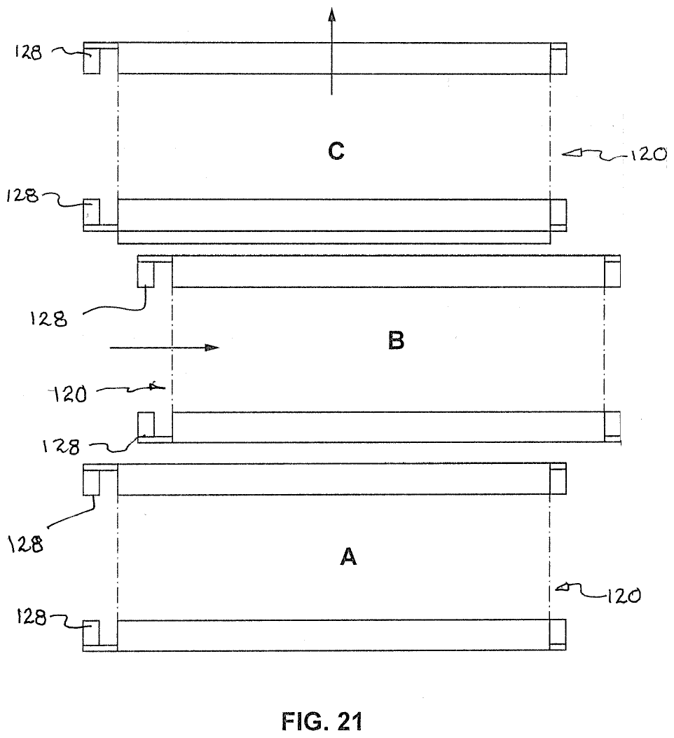

Gate assemblies 128 cover the openings 126. The gate assemblies 128 are movable between an open configuration show in FIGS. 15 and 17 and a closed configuration shown in FIGS. 16 and 18 in which they respectively open and close in the apertures 126.

The apertures 126 may be an array of slits as illustrated. The gate assembly 128 may comprise a respective frame 130 having corresponding slits 136 extending therethrough which register with the apertures 126 to permit ingress and egress of bees through the apertures 126 when the gate assembly 128 is in the open configuration.

A space 154 between the slits 136 is wider than the apertures 136 allowing the space 154 to cover the apertures 136 when the gate assembly 128 is moved into the closed configuration.

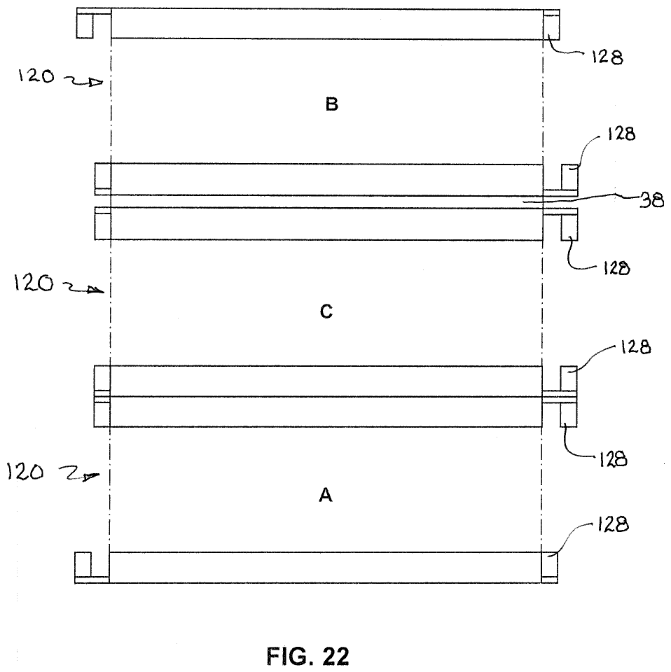

The beekeeping method using the hives 120 is illustrated in FIGS. 19 through 22.

FIG. 19 shows three beekeeping hives C, B and A stacked from top to bottom in that sequence. The bottom of the frame 30 of the B hive is in face-to-face juxtaposition with the top of frame 30 of the A hive with their openings registering so as to permit passage of bees from the A hive into the B hive. Similarly, the top of the frame 30 of the B hive and the bottom frame 30 of the C hive are in face-to-face juxtaposition with their openings registering so as to permit passage of bees between the B hive and the C hive.

Prior to the sequence illustrated in FIG. 19, the gate 34 on the bottom of the A hive would have been open to permit ingress of bees into the A hive. The A hive would typically house the queen bee and is generally used for rearing new bees. A queen excluder (not shown) would be utilized to prevent migration of the queen bee to the B and C hives.

The bees would use the B hive and C hive to make beeswax comb and to fill the comb with honey. Once the comb and honey are formed in the B hive, it will eventually fill up as bees prepare comb to be built in the C hive.

Once the B hive is filled, the gate assemblies 128 between the C, B and A hives would be closed. The gate assembly 128 on the bottom of the A hive would remain in its open configuration.

FIG. 20 shows the gate assemblies 128 being closed. Once the gate assemblies 128 are closed between each hive, the B hive is removed from between the C and A hives. As illustrated in FIG. 21, the B hive is removed from between the C hive and the A hive. The C hive is moved into the position previously occupied by the B hive. The B hive is in turn moved into the position formerly occupied by the C hive as shown in FIG. 22.

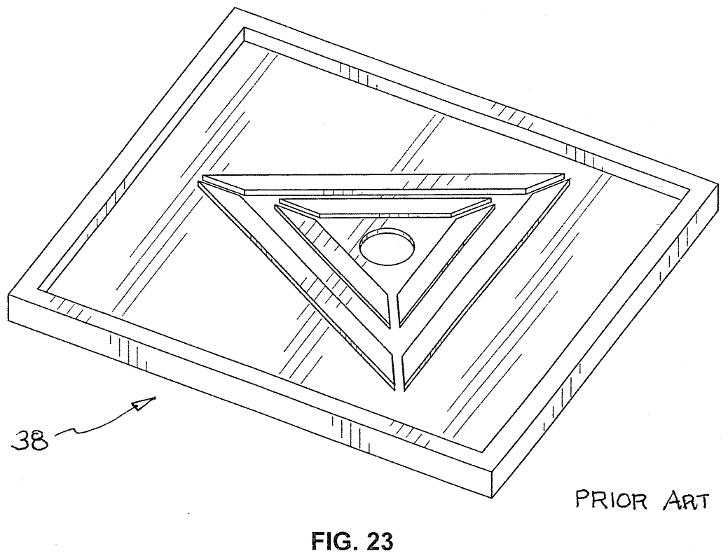

A bee escape 38 is placed between adjacent gates of the B hive and C hive as shown in FIGS. 19, 20 and 22. A bee escape 38 is a device used by beekeepers which acts as a unidirectional passageway between two openings. A typical bee escape 38 is shown in FIG. 23. The bee escape 38 would therefore be positioned to cause the bees to migrate from the B hive into the C hive.

The above description is intended in an illustrative rather than a restrictive sense. Variations may be apparent to those skilled in the art while remaining within the scope of the invention as defined by the claims set out below.

1. A beekeeping hive base comprising:
a container having a bottom and a continuous wall extending upwardly from said bottom about a perimeter thereof;
two or more spaced apart openings extend through said wall* and each of said openings positioned so as to allow registering with corresponding said openings of adjacent said hive bases; and
a respective gate assembly mounted to said sidewall for selectively closing and opening each said opening.

2. A beekeeping hive base according to claim 1 wherein said bottom is rectangular.

3. A beekeeping hive base according to claim 1 or 2 wherein said openings extend through opposite sides of said continuous wall.

4. A beekeeping hive base according to claim 1 wherein each of said gate assembly comprises a respective frame extending about each said opening and defining a channel for slidably receiving a moveable plate adjacent said opening, said frame having a passage therethrough which register with said opening to permit ingress and egress of bees through said opening when said gate assembly is in an open configuration.

5. A beekeeping hive base according to claim 1 wherein the beekeeping hive is a Top Bar hive.

6. A beekeeping method comprising the steps of:
(i) obtaining first, second and third or more beekeeping hives having bases according to claim 1;
(ii) placing the bases of the hives side by side adjacent to one another with the second hive being between the first and third hive and with openings aligned to allow movement of bees between said hives when said gates are in an open configuration;
(iii) opening both said gates on the first and second of said hives and opening the one of said gates on the third said hive which is between said second and third of said hives;
(iv) allowing bees to enter said first of said hives and to deposit honey into said second of said hives;
(v) closing said gates;
(vi) exchanging positions of said second hive with said first hive;
(vii) placing a bee escape between said second and first hives arranged to allow bees to escape into said first hive;
(viii) allowing said bees to escape from said second hive into said first hive by opening the gates between said second and first hives;
(ix) closing the gate of said second hive which is between said second hive and said first hive; and
(x) removing said honey from said second hive.

7. A beekeeping method comprising the steps of:
(i) obtaining first, second and third beekeeping hives having bases according to claim 1;
(ii) placing the bases of the first, second and third hives side by side adjacent to one another with the second hive being between the first and third hive and with openings aligned to allow movement of bees between said hives when said gates are in an open configuration;
(iii) opening both said gates on the first and second of said hives and opening the one of said gates on the third said hive which is between said second and third of said hives;
(iv) allowing bees to enter said first of said hives and to deposit honey into said second of said hives;
(v) closing said gates;
(vi) exchanging positions of said second hive with said first hive;
(vii) placing said second hive with one of said gates adjacent a portal through a structure housing said hives;
(viii) placing a bee escape between said gate and said portal;
(ix) opening said gate adjacent said portal;
(x) allowing said bees to escape through said portal; and
(xi) harvesting honeycomb from said second hive.

8. A beekeeping hive comprising:
a base;
a continuous sidewall extending about a perimeter of said base;
a removable lid for covering a top of said enclosure;
said lid and said base each having at least one aperture therethrough;
said at least one aperture of said lid being located so as to register with said at least one aperture through a base of an adjacent beekeeping hive to permit passage of bees between said adjacent beekeeping hives;
a respective gate connected to said base and said lid for opening and closing said apertures.

9. The beekeeping hive of claim 8 wherein said lid and said base each have a plurality of said apertures.

10. The beekeeping hive of claim 8 wherein each said respective gate is slidably mounted respectively to said lid and to said base.
